(19) United States
(12) Patent Application Publication
(10) Pub. No.: US 2021/0146671 A1
(43) Pub. Date: May 20, 2021

(54) METHOD TO EMULATE AN OIL PAINTING

(71) Applicant: ROBERT J. MABBOTT, Sarasota, FL (US)

(72) Inventor: ROBERT J. MABBOTT, Sarasota, FL (US)

(21) Appl. No.: 16/951,022

(22) Filed: Nov. 18, 2020

Related U.S. Application Data
(60) Provisional application No. 62/938,266, filed on Nov. 20, 2019.

(51) Int. Cl. B32B 37/00; B32B 38/00; B05D 5/06; B05D 1/28

(52) U.S. Cl. CPC B32B 37/025; B32B 38/145; B32B 2451/00; B05D 1/28; B32B 2307/4023; B05D 5/06

(57) ABSTRACT

An inkjet image printed onto a absorbable coated releasable carrier, transposed and adhered permanently to a surface designed for oil painting on, the removal of the releasable carrier, the exposure of a muted surface which color may be of a ghosted white, with the printed image being hidden from view and an oil being brushed into the ghosted white color surface to reveal the underlying color image, thereafter creating a finished oil painting.

### CROSS REFERENCE TO RELATED APPLICATION

This application claims the benefit of priority to provisional patent application 62/938266 filed Nov. 20, 2019.

### FIELD OF THE INVENTION

The present invention relates to the repeatable emulation of oil paintings using artistic endeavor and digital source media in the form of a mirrored digital print, printed on to an ink receptive absorbing layer, thereafter transposed and permanently affixed to a surface designed for oil painting on, before being revealed using oil absorption, brought about by the action of loading a paint brush with oil and brushing over the transposed image surface until all of the underlying image is clearly visible, thereafter completing the oil painting emulation method by the process of polymerization.

### BACKGROUND OF THE INVENTION

Oil painting on canvas is a timeless painting technique, which dates back to the early part of the 15^{th} Century, when Jan van Eyck, a famous Belgian painter began mixing linseed oil and oil from nuts with diverse colors. Since then drying oils like linseed oil has been a common carrier used in the oil painting process Drying oil can also be used as a painting medium, making color oil paints more fluid, transparent and glossy. They can also used as transparent mediums, for use in the process of over painting or under painting.

Emulation of original art has been around for centuries. Students would learn how to oil paint like a master by emulating a master at work. Over the years popular paintings have been copied by artists to provide less expensive versions of the original painting. While only one individual or institution can own an original painting, many people can own a copy or reproduction of that same painting. In 1950 Paint by Numbers kits became the first massed produced oil painting emulation method. A mix between a coloring book and painting on a canvas, paint by numbers for the first time allowed anyone to create an oil painted work of art, even if they had never taken an art class. Paint by numbers is a process where an original picture is created, divided into shapes, each of which is marked with a number which corresponds to a particular color, the user paints in each shape and the picture ultimately emerges as a finished oil painting. With the advent of computers, came the digital revolution and in 1991 the ability to print directly to the canvas material itself became a reality, thereby giving the ability to create a good facsimile of an oil painting, with no artistic endeavor.

Since then, the ability to print any picture onto a canvas has become both affordable and popular among all age groups and because of this has grown exponentially. However, canvas prints lack any artistic interaction and rarely compare well to an original oil painting, despite the fact that there are numerous computer and phone apps that enable oil painted effects and brush strokes to be simulated and incorporated into a digital print. Paint by numbers on the other hand are all about artistic endeavor and although they now embrace digital output as the original, lack the quality of emulation of a real oil painting.

Taking all the above in consideration, it has therefore been determined that there is a need for an oil painting process that closely follows the traditional oil painting techniques of brushing oil-based paint into the genuine canvas, one that enables anyone with little or no skill to achieve the same artistic result as someone that has all the skill of an artist, all with the ability to incorporate the process of digital printing, to enable both the consistency and reliability of the oil painting process.

### SUMMARY OF THE INVENTION

The present invention relates to the repeatable emulation of oil paintings using artistic endeavor and digital source media in the form of digital printing, printed on to an absorbing layer affixed to a releasable carrier, thereafter transposed and permanently bonded to a surface designed for oil painting on, before being revealed using oil absorption; brought about by the action of loading a paint brush with oil and brushing over the transposed image surface until all of the underlying image is clearly visible, thereafter completing the oil painting emulation process.

The present invention provides a process whereby anyone can create an oil painting based on the original art, maintaining both the quality and originality of emulation.

In a preferred embodiment, the present invention is performed and executed using a number of procedural steps, which steps may be segmented for the purpose of manufacture as follows: coating an absorbable layer onto a releasable carrier;

printing said layer with an ink derived image;

coating a suitable oil painting surface with a primer layer;

coating the primed oil painting surface with an adhesive layer;

placing the image face of the coated releasable carrier onto the adhesive layer of the oil painting surface;

applying moderate to high pressure to the upper releasable carrier surface to create a strong adhesive bond between the printed absorbable layer and the oil painting surface;

removing the upper releasable carrier from the printed image layer, which surface may appear muted;

brushing an oil based drying medium into the surface of the muted absorbable layer with a paint brush, thereby revealing the underlying printed image;

exposing the surface of the drying medium to air, thereby enabling the polymerization of the oil-based drying medium;

finishing the oil painted surface with a finishing medium;

In carrying out the preferred embodiment of the present invention, the first step is to select the appropriate releasable carrier and absorbable coating. In this regard, the carrier should be of a film construction, which is flexible and soft with good heat and stress, dimensional stability. The releasable carrier should also have release properties which enable wet coating, avoiding surface reticulation and once dried should be sufficiently adhered to the surface to be printed using ink printing equipment, but retain excellent release properties to enable the easy and complete release of the absorbable coating layer during the application process. The absorbable coating may be of a microporous formulation of which visibility on curing should be seen as opaque white.

Once the absorbable coated releasable carrier has been printed it is then ready to be applied to a suitable oil painting surface, which may be a commercially available textured canvas in roll form, a stretched canvas, a canvas board or canvas panel, or other suitable oil painting surface.

Before it can be applied to the surface it will need preparing for the printed image to be permanently adhered to its surface. First a suitable primer should be coated onto the surface, which primer may be one and the same or a modified version of the absorbable coating layer used to coat the releasable carrier. Next a suitable adhesive will need to be coated onto the primer layer.

The type of adhesive that is specific to the requirements of use, which adhesive needs to bond permanently to the primed layer of the painting surface that is used and maintain the integrity of the inkjet coating and image once it has been applied. The adhesive should be impervious to oil-based liquids, having adhesive qualities consistent with a heat activated or pressure sensitive type adhesive, either being sufficient to allow the releasable carrier to be removed cleanly without movement of the image.

Once the coating on the releasable carrier has been secured to the painting surface and subsequently removed, the printed image will appear muted (hidden from view) as it will be on the underside of the white absorbable coating.

The final part of the process is when the oil is brushed into and absorbed into the muted absorbable coating surface, which action causes the coating to change from white to clear thereby causing the underlying image to become completely visible. The oil that is most desirable for this process is an oil that can be absorbed and on exposure to air, cure by the process of polymerization, more particularly an oil that is derived from the nuts of a tung tree.

Absorption rates of the oil are based on the relative viscosity of the oil, the coating thickness and pore size of the microporous coating itself. The higher the rate of absorption, the closer the ink is to the surface. This can significantly change the relative opacity of the inkjet coating prior to the oil being brushed into its surface, but does not affect the final oil painted result. Once the oil is dry to the touch, it can have different brushed or sprayed, glazes, varnishes and effects applied to its surface.

The above brief description of the art has been designed to give a skeletal understanding of what is to be understood as the essence of the present invention, however it is not designed in any way to limit the present invention and is to be considered by no means exhaustive, accordingly, the present invention is not limited to the precise embodiments, drawings or descriptions detailed herein.

An object of the present invention is to provide a layer construction, comprising a first releasable carrier coated with an absorbable layer wherein the first releasable carrier may be constructed of a flexible film substrate, which may be an extruded or cast polypropylene material with release properties consistent with the requirements of the application process and subsequent removal of the releasable carrier from the absorbable layer, which nature is required to be porous, which may that of a micro or nano-porous structure, all consistent with the requirements of absorption.

Another object of the present invention is to provide an oil painting surface with a primer layer, which layer may be the same as, or a modified version of the absorbable coating layer, onto which an adhesive layer may be coated, said adhesive layer may be designed to be heat or pressure sensitive, to a degree consistent with the requirements of the release of a releasable carrier and the bonding of the transposed ink absorbable coating layer. There are many such suitable adhesives, which may be both permanent or removable, which adhesive nature may allow for different bond and release application methods to be used.

Another object of the present invention is to provide an additional layer, which is over painted or coated onto the absorbable coating layer after printing, but before it is transposed onto the oil painting surface. For the purpose of illustration, the over paint layer may be that of a color, or several colors that may promote different effects to be seen in the final oil painting, such effects may include glow in the dark, metallic or holographic, it may even be a layer that is painted or printed in relief, for example texture paste to promote both the visual and physical appearance of brush strokes made visible in the final oil painting.

### BRIEF DESCRIPTION OF THE DRAWINGS

In the following description, reference will be made to the attached drawings in which:

FIG. 1 is a cross section showing the material structure and layer construction of the absorbableink receptive releasable carrier;

FIG. 2 is a cross section the same as FIG. 1 showing a printed inkjet image absorbed into theabsorbable coating;

FIG. 3 is a cross section the same as FIG. 2 showing the addition of a texture layer which maybe used to make brush strokes;

FIG. 4 is a cross section showing a primed oil painting surface coated with an adhesive;

FIG. 5 is a cross section showing the pressing of the image face of the coated releasable carrieronto the adhesive layer of the oil painted surface;

FIG. 6 is the same as FIG. 5 only with the removal of the releasable carrier;

FIG. 7 is a cross section showing droplets of oil being absorbed into the absorbable layer and printed inkjet image; and

FIG. 8 is a cross section the same as FIG. 7 after the oil has been fully absorbed into the surface air dried and fully reacted by the process of polymerization.

### DESCRIPTION QF PREFERRED EMBODIMENTS

In the following description and drawings and for purposes of explanation, numerous specific details are set forth in order to provide a more complete understanding of the present invention. It will be evident, however, to one with ordinary skill in the art that the present invention may be practiced without these specific details. The present disclosure is to be considered as an exemplification of the invention, and is not intended to limit the invention to the specific embodiments illustrated by the figures or to the detailed description of the drawings herein.

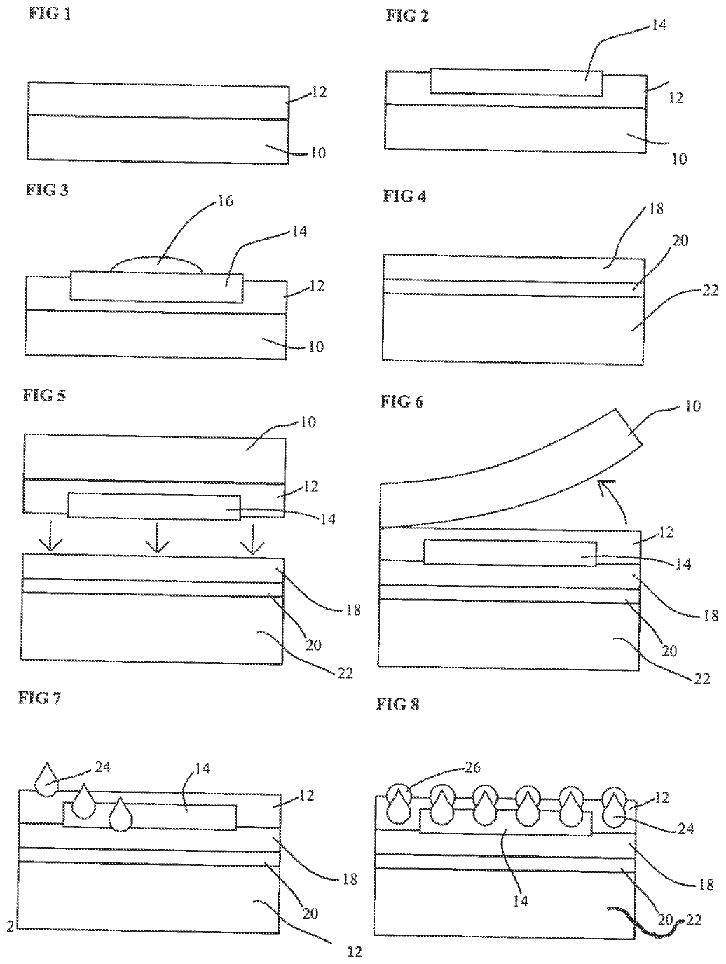

FIG. 1 is a cross section showing a releasable carrier 10 and coating construction that comprise the following; a releasable carrier 10 that may be made from film which material may be a clear non oriented polypropylene of a thickness of between 140-160 microns, corona treated to a surface energy of +/−38 dynes/cm. Material should exhibit excellent lay flat characteristics together with a high elongation at break of +/−600% in both the MD and TD directions. Surface may be textured to aid release characteristics and surface finish; The coated construction of the releasable carrier 10 may be that of an absorbable coating 12 with the appearance of a white opaque liquid, coating should be able to be printed using waterbased pigment inkjet ink, but may be print compatible with other ink technologies. It is a requirement of the absorbable coating 12 to be enabled to absorb oil-based drying mediums of the kind consistent with the use and application of tung or linseed oil 24 a suitable coating may be that of a white matte microporous inkjet coating, coated onto the releasable carrier 10 to a preferred thickness of between 50 and 70 microns. One such suitable coating is a matte inkjet receptive microporous formulation which product name is PrintRite DP 338 commercially available from Lubrizol.

FIG. 2 is a cross section the same as FIG. 1 showing a printed inkjet image 14 absorbed into the absorbable coating 12 there are many different types of ink that will work with this type of coating, some of which have no absorption characteristics, and some that have the ability to penetrate the entire coating layer, however the present invention uses absorbable waterbased pigment or dye based ink in order to improve the color gamut, maintain the ink density, print contrast, and resolution with fast even drying of the ink.

FIG. 3 is a cross section the same as FIG. 2 showing the addition of a texture medium 16 which may be used to make brush strokes of the type described herein, can be made from a number of different types of material, the criteria of suitability being that they are able to be applied to the printed inkjet image 14 onto the absorbable coating 12 and adhered to that surface in a permanent way. There are many different types of mediums that may fit the criteria, many of which are commercially available from art and craft suppliers and sold as texture gels or impasto painting mediums. For the purpose of the present invention, the addition of a raised profile enables real brush strokes to be added to the printed inkjet image 14 absorbable coating 12 surface, thereafter, being transposed to be revealed on application as an integral part of the finished oil painting.

FIG. 4 is a cross section showing a surface used to oil paint on 22 coated with a white pigmented gesso primer 20 coated thereon, with an adhesive 18 which may be of the type herein described as a pressure activated synthetic, that allows material to be positioned and repositioned for accurate alignment, when little or no pressure is applied, yet forms a high strength permanentbond when the required amount of pressure is applied.

FIG. 5 is a cross section showing the pressing of the image face of the coated releasable carrier 10 onto the adhesive 18 layer of the oil painting surface 22 the action of pressing the image face of the coated release carrier 10 as described is fundamental to the successful outcome of the present invention and the preferred embodiment herein.

The action may be that of non-apparatus, as would be achieved by pressing or rolling by hand or may be that of using motorized equipment, for example by roll lamination, vacuum application or heat press.

FIG. 6 is the same as FIG. 5 only with the removal of the releasable carrier 10 the releasable carrier 10 as described, may be removed by the action of hand peeling, given that the peeling process occurs after the material surface has been rubbed down sufficiently as to contact the printed inkjet image 14 absorbable coating 12 layer to full contact and engage the microsphere adhesive 18 coated surface of the oil painting surface 22 the releasable carrier 10 may also be removed by mechanical means, in which case the same conventions of removal of the releasable carrier 10 would apply.

FIG. 7 is a cross section showing oil 24 droplets being absorbed into the absorbable coating 12 the delivery system used to enable oil absorption to take place is a brush, which may be likenedto a normal artists oil painting brush or may be another type of brush. Artists brushes are used to collect and deliver liquid in the form of paint and mediums to the surface of an oil painting surface, stroke by stroke. The amount of liquid that is collected and delivered to the surface is based on the skill of each individual. When using oil 24 the amount and accurate control of the delivery of the oil to the surface is a feature of the present invention. In this regard, a brush that has the ability to deliver a controlled amount of oil to the surface, may be that of a brush pen, that has liquid loaded into the pen barrel, a brush where the nib would normally be, and a mechanism to adjust the pressure and flow of the droplets that are delivered to the surface and then brushed into the surface using the same brush. These types of brushes are available as water refillable brush pens, but it is a feature of the present invention to use such a brush pen to deliver oil and different liquid-based mediums in the same style pen with or without the ability to refill it when it is empty. Oil 24 is delivered to the oil painting surface 22 which face is muted and the underlying image is hidden from view by a white ghosted effect. As the oil 24 is brushed into the surface it is is absorbed and the printed image 14 is revealed as the ghosting gives way to color and the image gradually becomes fully visible.

FIG. 8 is a cross section the same as FIG. 7 after the oil 24 has been brushed into the surface and fully absorbed into the surface, air dried and fully reacted by the process of polymerization. Polymerization 26 of the oil 24 occurs when the oil 24 is exposed to air, it is a natural process that both hardens the oil and seals the surface for finishing.

While the disclosed subject matter has been described in conjunction with a number of embodiments, it is evident that many alternatives, modifications and variations would be, or are, apparent to those of ordinary skill in the applicable arts. Accordingly, applicant intends to embrace all such alternatives, modifications, equivalents and variations that are within the spirit and scope of the disclosed subject matter.

What is claimed is:

1. A method of emulating an oil painting, comprising the steps of:
printing an inkjet image onto an absorbable coated releasable carrier sheet construction;
transposing the absorbable coated releasable carrier sheet construction so the image is hidden from view and the upper surface is muted and ghosted white;
aligning and positioning the absorbable coated releasable carrier sheet construction;
pressing and adhering the absorbable coated releasable carrier sheet construction to the adhesive surface of the oil painting surface;
removing the releasable carrier sheet;
exposing the muted ghosted white surface of the absorbable coating;
brushing oil into to absorbable coating surface; and
revealing the underlying printed inkjet image thereafter creating a finished oil painting.
